(19) United States
(12) Patent Application Publication
(10) Pub. No.: US 2009/0022208 A1
(43) Pub. Date: Jan. 22, 2009

(54) METHOD AND SYSTEM FOR RAPIDLY DETECTING THE PRESENCE OF INTERFERERS IN BLUETOOTH FREQUENCY HOPPING

(76) Inventors: Steven Deane Hall, Olivenhain, CA (US); Brima Ibrahim, Aliso Viejo, CA (US); Hea Joung Kim, Irvine, CA (US); Yuan Zhuang, San Diego, CA (US); Langford Wasada, Poway, CA (US); Bojko Marholev, Irvine, CA (US); Shawn Ding, San Diego, CA (US); Latha Caliaperoumal, San Diego, CA (US); Satya Prasad Srinivas, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 12/017,135

(22) Filed: Jan. 21, 2008

Related U.S. Application Data
(60) Provisional application No. 60/950,369, filed on Jul. 18, 2007.

(51) Int. Cl. H04B 1/00

(52) U.S. Cl. 375/132; 375/E01.033

(57) ABSTRACT

Methods and systems for wireless communication are disclosed and may include sweeping a signal detection frequency one or more times across a plurality of steps in a frequency range. The measured signal strength at each step may be compared to a threshold, and a status may be stored, which may depend on the presence of a measured signal strength above threshold. The detection frequency may be swept utilizing a voltage controlled oscillator, which may be tuned via a control voltage and/or calibration capacitors. Steps may be skipped when a measured signal strength may be greater than the threshold, and may occur after multiple above threshold measurements. The steps may have variable frequency width, and the range may include the Bluetooth band from 2.40 GHz to 2.48 GHz. The frequency may be swept over a subset of the Bluetooth band, and may be swept on a periodic basis.

### CROSS-REFERENCE TO RELATED APPLICATIONS/INCORPORATION BY REFERENCE

This application makes reference to and claims priority to U.S. Provisional Application Ser. No. 60/950,369 filed on Jul. 18, 2007, which is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to wireless communication. More specifically, certain embodiments of the invention relate to a method and system for rapidly detecting the presence of interferers in Bluetooth frequency hopping.

### BACKGROUND OF THE INVENTION

As mobile, wireless, and/or handheld portable devices increasingly become multifunctional, “all-in-one,” communication devices, these handheld portable devices include an increasingly wide range of functions for handling a plurality of wireless communication services. For example, a single handheld portable device may enable Bluetooth communications and wireless local area network (WLAN) communications.

Much of the front end processing for wireless communications services is performed in analog circuitry. Front end processing within a portable device may comprise a range of operations that involve the reception of radio frequency (RF) signals, typically received via an antenna that is communicatively coupled to the portable device. Receiver tasks performed on an RF signal may include downconversion, filtering, and analog to digital conversion (ADC), for example. The resulting signal may be referred to as a baseband signal. The baseband signal typically contains digital data, which may be subsequently processed in digital circuitry within the portable device.

Front end processing within a portable device may also include transmission of RF signals. Transmitter tasks performed on a baseband signal may include digital to analog conversion (DAC), filtering, upconversion, and power amplification (PA), for example. The power amplified, RF signal, is typically transmitted via an antenna that is communicatively coupled to the portable device by some means. The antenna utilized for receiving an RF signal at a portable device may or may not be the same antenna that is utilized for transmitting an RF signal from the portable device.

The analog RF circuitry for each separate wireless communication service may be implemented in a separate integrated circuit (IC) device (or chip). This may result in increased chip and/or component count that may limit the extent to which the physical dimensions of the portable device may be miniaturized. This may result in physically bulky devices, which may be less appealing to consumer preferences.

Along with increased chip and/or component count, there may also be a corresponding rise in power consumption within the portable device. This may present another set of disadvantages, such as increased operating temperature, and reduced battery life between recharges.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for rapidly detecting the presence of interferers in Bluetooth frequency hopping, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary mobile terminal that comprises a Bluetooth radio, in accordance with an embodiment of the invention.

FIG. 2 is a block diagram illustrating channels in the Bluetooth frequency band in a Bluetooth wireless system, in accordance with an embodiment of the invention.

FIG. 3 is a block diagram illustrating a Bluetooth channel interferer detection system, in accordance with an embodiment of the invention.

FIG. 4 is a flow diagram illustrating an exemplary Bluetooth channel sweep with skipped bands where the frequencies in the skipped band are skipped during the scan, in accordance with an embodiment of the invention.

FIG. 5 is a flow diagram illustrating an exemplary Bluetooth channel sweep without skipped bands, in accordance with an embodiment of the invention.

FIG. 6 is a flow diagram illustrating an exemplary Bluetooth channel sweep with skipped bands where the signal is ignored in the skipped band, in accordance with an embodiment of the invention.

### DETAILED DESCRIPTION OF THE INVENTION

Certain aspects of the invention may be found in a method and system for rapidly detecting the presence of interferers in Bluetooth frequency hopping. Exemplary aspects of the invention may comprise sweeping a signal detection frequency one or more times across a plurality of steps in a frequency range. The measured signal strength at each of the plurality of steps may be compared to a threshold, and a status may be stored for each of the plurality of steps. The status may be dependent on the presence of a measured signal strength above the threshold. The signal detection frequency may be swept utilizing a voltage controlled oscillator, which may be tuned via a control voltage and/or calibration capacitors. One or more steps may be skipped in the sweeping of the signal detection frequency when a signal strength measured at the one or more steps may be greater than the threshold. The skipping of the one or more steps may occur after more than one of the measurements of the signal strength may be above the threshold. The plurality of steps may be of a variable frequency width, and the frequency range may comprise the Bluetooth frequency band from 2.40 GHz to 2.48 GHz. The detection frequency may be swept over a subset of the Bluetooth frequency band, and may be swept on a periodic basis.

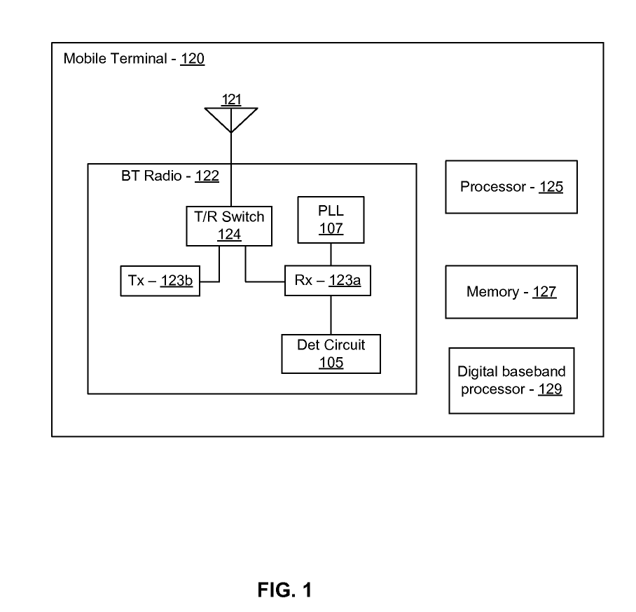

FIG. 1 is a block diagram illustrating an exemplary mobile terminal that comprises a Bluetooth radio, in accordance with an embodiment of the invention. Referring to FIG. 1, there is shown mobile terminal 120 that may comprise a Bluetooth (BT) radio 122, a BT digital baseband processor 129, a processor 125, and a memory 127. The BT radio 122 may comprise a BT Receiver (Rx) 123a, a BT Transmitter (Tx) 123b, a detection circuit 105, a phase locked loop (PLL) 107 and a T/R switch 124. In some embodiments of the invention, the BT Rx 123a, and BT Tx 123b may be integrated into a BT transceiver 122, for example. A single transmit and receive antenna 121 may be communicatively coupled to the BT Rx 123a and the BT Tx 123b. A T/R switch 124, or other device having switching capabilities may be coupled between the BT Rx 123a and BT Tx 123b, and may be utilized to switch the antenna 121 between transmit and receive functions.

The BT Rx 123a may comprise suitable logic, circuitry, and/or code that may enable processing of received BT RF signals. The BT Rx 123a may be communicatively coupled to the T/R switch 124 and may enable reception of RF signals in frequency bands utilized by BT communication systems.

The detection circuit 105 may comprise suitable circuitry, logic and/or code that may enable detection of signals received via the antenna 121 and the T/R switch 124. The detection circuit 105 may enable measurement of the received signal strength indication (RSSI) for determining the spectrum of signals received by the BT radio 122.

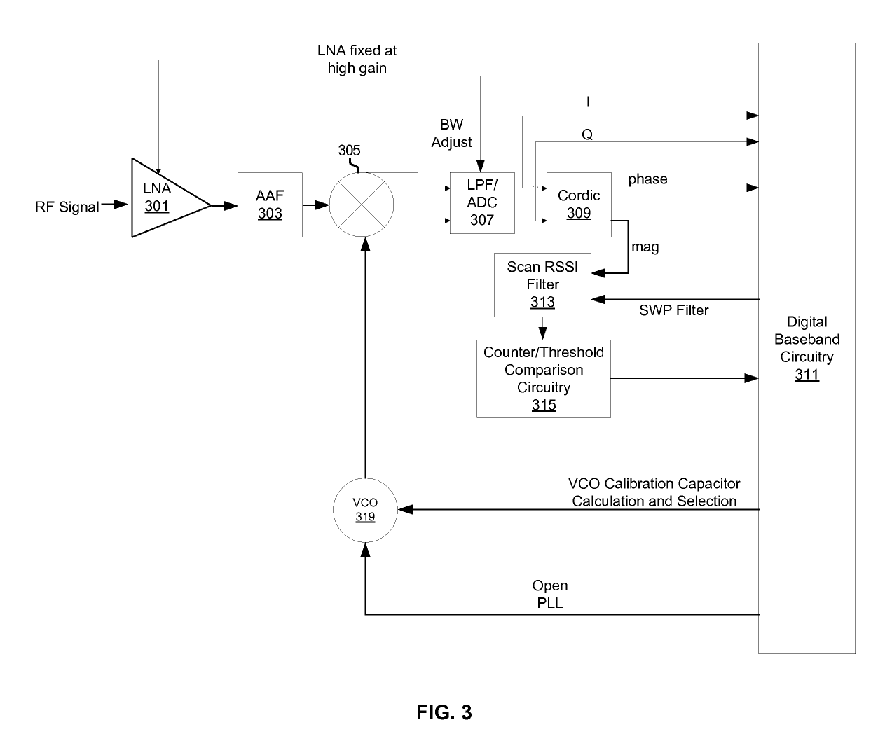

The PLL 107 may comprise suitable circuitry, logic and/or code that may enable frequency tuning the BT Rx 123a. The PLL 107 may be utilized to lock the BT Rx 123a to a desired frequency channel, and may be tuned by adjusting a voltage controlled oscillator (VCO) via a control voltage and/or calibration capacitors, described further with respect to FIG. 3.

The BT digital baseband processor 129 may comprise suitable logic, circuitry, and/or code that may enable processing and/or handling of BT baseband signals. In this regard, the BT digital baseband processor 129 may process or handle BT signals received from the BT Rx 123a and/or BT signals to be transferred to the BT Tx 123b for transmission via a wireless communication medium.

The BT digital baseband processor 129 may also provide control and/or feedback information to/from the BT Rx 123a, the BT Tx 123b and the detection circuit 105, based on information from the processed BT signals. The BT digital baseband processor 129 may communicate information and/or data from the processed BT signals to the processor 125 and/or to the memory 127. Moreover, the BT digital baseband processor 129 may receive information from the processor 125 and/or to the memory 127, which may be processed and transferred to the BT Tx 123b for transmission of BT signals via the wireless communication medium.

The BT Tx 123b may comprise suitable logic, circuitry, and/or code that may enable processing of BT signals for transmission. The BT Tx 123b may be communicatively coupled to the T/R switch 124 and the detection circuit 105, and may enable transmission of RF signals in frequency bands utilized by BT systems.

The processor 125 may comprise suitable logic, circuitry, and/or code that may enable control and/or data processing operations for the mobile terminal 120. The processor 125 may be utilized to control at least a portion of the BT Rx 123a, the BT Tx 123b, the detection circuit 105, the BT digital baseband processor 129, and/or the memory 127. In this regard, the processor 125 may generate at least one signal for controlling operations within the mobile terminal 120.

The memory 127 may comprise suitable logic, circuitry, and/or code that may enable storage of data and/or other information utilized by the mobile terminal 120. For example, the memory 127 may be utilized for storing processed data generated by the BT digital baseband processor 129 and/or the processor 125. The memory 127 may also be utilized to store information, such as configuration information, that may be utilized to control the operation of at least one block in the mobile terminal 120. For example, the memory 127 may comprise information necessary to configure the BT Rx 123a to enable receiving BT signals in the appropriate frequency band, by storing the status of a spectrum of BT channels. The status of a BT channel may comprise information such as whether or not the channel is currently utilized by another wireless device, such as WLAN, for example.

In operation, the BT Rx 123a and the BT Tx 123b may be enabled to receive and transmit BT signals, respectively. The BT Rx 123a may be enabled to sweep the BT reception frequency in a step-wise fashion across the entire BT frequency band, and/or a subset thereof. The PLL 107 may be run in an open loop mode, in which the PLL 107 is not allowed to lock on each frequency. Running the PLL 107 in an open loop mode allows the speed of the scan to be increased. Each step, or frequency range, of the sweep may comprise a BT channel. The detection circuit, via the BT Rx 123a, may measure the received signal strength indicator (RSSI) at each channel.

In instances when the received signal in a particular channel may be above a threshold, that particular channel may be used by another wireless device, and as such may be unavailable for use by the BT radio 122. The status of the used, or “bad” BT channel may then be stored in the memory 127. Accordingly, the status of any BT channel that may not contain a signal that exceeds a threshold may be stored in the memory 127 as a “good” channel. A number of registers may be defined in the memory 127 for storing the status of a plurality of BT channels.

The sweeping of the frequency of the BT Rx 123a may be performed in transitions between transmission to reception and reception to transmission in the normal operation of the BT radio 122. BT radios, such as the BT radio 122 may hop frequencies during normal operation, and determining the available channels may enable efficient and fast switching.

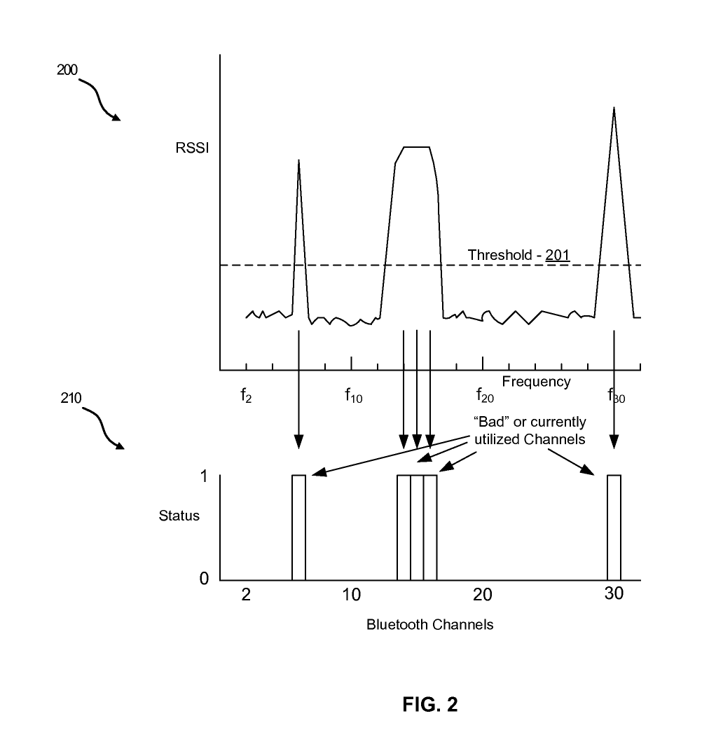

FIG. 2 is a block diagram illustrating channels in the Bluetooth frequency band in a Bluetooth wireless system, in accordance with an embodiment of the invention. Referring to FIG. 2, there is shown a RSSI versus frequency (RSSI vs. f) plot 200 and a BT channel status plot 210. The RSSI vs. f plot 200 may show the measured RSSI over the BT frequency band. The frequencies of individual channel may be represented by f₂, f₁₀, f₂₀ and f₃₀ on the x-axis, for example. The threshold 201 in the RSSI vs. f plot 200 may comprise a predetermined level, a signal measured above which may constitute a “bad” channel.

The BT channel status plot 210 may indicate the status of each channel in the measured BT frequency range, which may comprise the entire BT spectrum, or a subsection thereof. In instances where the RSSI measured at a particular frequency that corresponds to a particular channel exceeds the threshold 201 in the RSSI vs. f plot 200, the status of the channel in the BT channel status plot 210 may be equal to ‘1’. For example, in the RSSI vs. f plot 200, the RSSI for f₆, f₁₄, f₁₅ and f₁₆ may exceed the threshold level 201, which may be indicated by a status of ‘1’ in the BT channel status plot 210, and the status of channels where the measured RSSI may be below the threshold 201 may be indicated by a status of ‘0’.

In addition to determining the status of a particular channel, the sweep of the BT reception frequency may also generate information about the source of the signals in the “bad” channels, or interferers. A signal with a wider bandwidth may comprise a WLAN signal, for example. The BT interferer sweep may be repeated a number of times, or on a regular basis, for example, to determine the time dependencies of the interferers. In instances where it may be determined that one or more channels may be consistently “bad”, subsequent frequency sweeps may skip these channels, and they may also be skipped in the channel hopping of the BT radio 122.

FIG. 3 is a block diagram illustrating a Bluetooth channel interferer detection system, in accordance with an embodiment of the invention. Referring to FIG. 3, there is shown a low noise amplifier (LNA) 301, an anti-aliasing filter (AAF) 303, a mixer 305, a low pass filter and analog to digital converter (LPF/ADC) 307, a coordinate rotation digital computer (cordic) 309, digital baseband circuitry 311, an RSSI filter 313, counter/threshold comparison circuitry 315 and a voltage controlled oscillator (VCO) 319.

The LNA 301 may comprise suitable circuitry, logic and/or code that may enable the amplification of received RF signals. The LNA 301 may comprise one or more amplification stages, for example, and may be communicatively coupled to the AAF 303 and the digital baseband circuitry 311. The LNA 301 may receive as an input, a signal from the digital baseband circuitry 311 to set the gain, and the output of the LNA 301 may be communicatively coupled to the AAF 303.

The AAF 303 may comprise suitable circuitry, logic and/or code that may enable filtering of the signal received at its input. The AAF 303 may comprise a bandpass filter that may cover the bandwidth of the Bluetooth frequency range. In an alternative embodiment of the invention, the AAF 303 may comprise a low pass filter, with a corner frequency higher that the Bluetooth maximum frequency.

The mixer 305 may comprise suitable circuitry, logic and/or code that may enable down-conversion of the frequency of a received signal to a frequency that may be equal to the difference of the received signal and that of another input signal, which may be supplied by the VCO 319, for example. In an embodiment of the invention, the mixer 305 may be enabled to generate in-phase and quadrature (I and Q) output signals from the received signal.

The LPF/ADC 307 may comprise suitable circuitry, logic and/or code that may enable filtering received analog signals and generating digital output signals. The LPF/ADC 307 may be enabled to receive an input signal, pass signals below a determined cutoff frequency, and attenuate signals with frequencies above the cutoff frequency before converting to a digital signal to be communicated to the digital baseband circuitry 311 and/or the cordic 309. In this manner, a lower frequency modulation signal may pass through the LPF/ADC 307, while a higher frequency carrier signal may be attenuated, for example.

The cordic 309 may comprise suitable circuitry, logic and/or code the may enable the generation of a magnitude signal from received I and Q signals. The cordic 309 may comprise an efficient and high speed calculation block, that may only require addition, subtraction, bit shift and table lookup to perform more complex mathematical functions. The input signals received by the cordic 309 may comprise the I and Q output signals generated by the LPF/ADC 307, and as such, the cordic 309 may utilize trigonometric function algorithms to determine magnitude and phase signals. Since the calculation functions in the cordic 309 may be shared, it may be utilized in a plurality of functions in a BT system, such as in demodulation, for example. The phase output signal of the cordic 309 may be communicatively coupled to the digital baseband circuitry 311, and the magnitude output signal may be communicatively coupled to the RSSI filter 313.

The digital baseband circuitry 311 may comprise suitable circuitry, logic and/or code that may enable the processing of digital baseband signals generated by the reception of signals by the LNA 301. Additionally, the digital baseband circuitry 311 may generate control signals for the RF front end 301, the LPF/ADC 307, the RSSI filter 313 and the VCO 319. In an embodiment of the invention, the digital baseband circuitry 311 may also comprise a processor, such as the processor 125, described with respect to FIG. 1.

The RSSI filter 313 may comprise suitable circuitry, logic and/or code that may enable filtering of an input signal during a scan of the BT frequency band. The RSSI filter 313 may reduce noise spikes in the signal received from the cordic 309. The RSSI filter 313 may also receive control signals from the digital baseband circuitry 311 to tune the frequency response to correspond to that of the desired BT channel sweep.

The counter/threshold comparison circuitry 315 may comprise suitable circuitry, logic and/or code that may enable comparing the magnitude of a received signal to a reference threshold level, and measuring the time and/or number of cycles that a received signal may be above the threshold value. The counter/threshold comparison circuitry 315 may receive as an input, a signal generated by the RSSI filter 313, and may generate an output signal that may be communicatively coupled to the digital baseband circuitry 311.

The VCO 319 may comprise suitable circuitry, logic and/or code that may enable the generation of an output signal at a desired frequency that may be dependent on an input voltage and/or the capacitance of calibration capacitors coupled to the VCO 319. The frequency range of the VCO 319 may be tuned either via adjusting an input voltage, or by adjusting capacitors.

The VCO 319 may receive as an input, control signals from the digital baseband circuitry 311, and may generate an output signal that may be communicatively coupled to the mixer 305. The VCO 319 may correspond to a VCO in the PLL 107 described with respect to FIG. 1. The VCO 319 calibration capacitors may comprise switchable capacitors such that the digital baseband circuitry 311 may set the capacitance used to tune the VCO 319. Each possible capacitance may be identified by an identifier, VCO_CAL_CAP, with a variable step size which may be determined by the bit size of VCO_CAL_CAP, or the amount that VCO_CAL_CAP may be incremented, and the desired sweep speed and accuracy. In other words, the smaller step size may improve accuracy, but slow down the sweep.

In operation, the VCO 319 may be utilized to sweep the frequency of the signal communicated from the mixer 305 to the LPF/ADC 307. The VCO 319 may be run in open loop mode, to increase the speed of the sweep. The VCO 319 frequency may be tuned using voltage control and/or calibration capacitor control. The gain in the LNA 301 may be fixed at a high level for higher sensitivity to interferers. The AAF 303 may filter the received signal and generate an output that may be communicated to the mixer 305. The mixer 305 may down-convert the received signal to baseband frequencies, and may generate I and Q signals. In an embodiment of the invention, the mixer may down-convert the received signal to a low IF frequency range, or alternatively may direct-convert the received signal to baseband.

The generated I and Q output signals may be communicatively coupled to the LPF/ADC 307, which may further filter the signals and convert them to digital signals for processing by the digital baseband circuitry 311 and the cordic 309. The cordic 309 may generate phase and magnitude signals from the I and Q signals and may communicate the magnitude signal to the RSSI filter 313. The RSSI filter 313 may filter the magnitude signal and generate an output signal that may be communicated to the counter/threshold comparison circuitry 315. The counter/threshold comparison circuitry 315 may compare the filtered magnitude signal and compare it to a threshold value to determine the presence of an interfering signal. The threshold value may be temperature dependent, and may be adjusted accordingly by the digital baseband circuitry 311.

In instances when the counter/threshold comparison circuitry 315 may determine that the received signal is above the threshold, this may indicate that there may be an interferer, or bad channel. The frequency sweep may be repeated one or more times and/or may be performed on a periodic basis to verify the bad channel. In an embodiment of the invention, if a bad channel persists, subsequent frequency sweeps may skip the bad channels, to further increase sweep speed. In instances where there may be a wireless LAN (WLAN) system, for example, within the mobile terminal 120, the channel utilized by the WLAN may be permanently skipped by BT channel sweeps.

In an embodiment of the invention, the VCO 319 calibration capacitors and/or the controlling voltage may be periodically checked by allowing the PLL, such as the PLL 107, to lock at the low end and then the high end of the BT frequency range. The capacitor settings and/or VCO controlling voltage used at each of these frequencies may then be utilized to more accurately tune the frequencies between the high and low frequencies. The calibration capacitance settings may correspond to maximum and minimum values for VCO_CAL_CAP utilized to control the VCO 319.

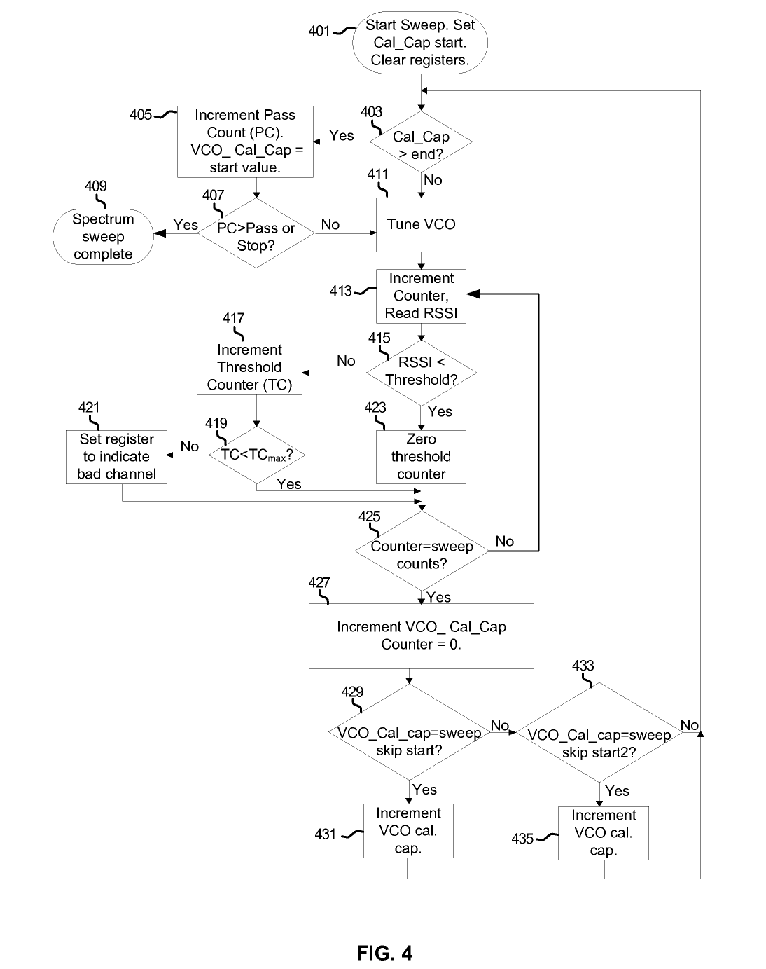

FIG. 4 is a flow diagram illustrating an exemplary Bluetooth channel sweep with skipped bands where the frequencies in the skipped band are skipped during the scan, in accordance with an embodiment of the invention. Referring to FIG. 4, in step 401, the frequency sweep may start with VCO_CAL_CAP set to the start value, which may correspond to the lowest frequency of the desired frequency sweep. The bad channel and counter registers may be cleared. In step 403, in instances where the VCO_CAL_CAP identifier may be greater than that calibrated for the maximum frequency of the sweep, the process may proceed to step 405 where the pass count (PC) may be incremented, and the VCO_CAL_CAP identifier may be set to the value corresponding to the low frequency in the BT frequency sweep, before proceeding to step 407. In step 407, in instances where the PC value may be greater than a pass or stop value, in other words, the number of desired frequency sweeps has been reached, the process may proceed to end step 409, spectrum sweep complete.

If in step 403, it is determined that the VCO_CAL_CAP identifier may not be above that which corresponds to the maximum frequency, the process may proceed to step 411, where the VCO 319 may be tuned to the desired frequency. In step 413, the counter, or number of scans made in a particular band, may be incremented, and the RSSI value measured.

In step 415, if the RSSI may be greater than the threshold value, the process may proceed to step 417 where the threshold counter (TC), which may indicate the number of times an interferer was measured in a channel, may be incremented, followed by step 419. In step 419, in instances where TC may be less than TCₘₐₓ, which may correspond to the number of times an interferer may be measured before considering or classifying a channel as being bad, the process may proceed to step 425. If TC may be greater than TCₘₐₓ, the process may proceed to step 421, where the register associated with the current measured channel may be set to indicate a bad channel, before proceeding to step 425. If, in step 415, the RSSI may be less than the threshold value, the process may proceed to step 423 where TC may be set to zero before proceeding to step 425.

In step 425, in instances where the counter may be less than the number of desired scans of each channel, the process may step back to step 413. In instances where the counter may be equal the number of desired scans of each channel, the process may proceed to step 427 where the VCO_CAL_CAP identifier may be incremented, and the counter may be set to zero to enable a count of the number of scans in the next channel.

In step 429, in instances where the VCO_CAL_CAP identifier may correspond to a first frequency to be skipped, such as with a known bad channel, for example, the process may proceed to step 431, where the VCO_CAL_CAP identifier may be incremented again to the end of the skipped band, and then proceed to step 403. If in step 429, the VCO_CAL_CAP identifier does not correspond to a first frequency to be skipped, the process may proceed to step 433. In step 433, in instances where the VCO_CAL_CAP identifier may correspond to a second frequency to be skipped, the process may proceed to step 435, where the VCO_CAL_CAP identifier may be incremented again to the end of the skipped band, and then proceed to step 403. If, in step 433, the VCO_CAL_CAP identifier does not correspond to the second frequency to be skipped, the process may proceed to step 403.

The process flow described in FIG. 4 is not limited to two skipped frequency bands. Accordingly, any number of skipped bands may be utilized as required by the BT system.

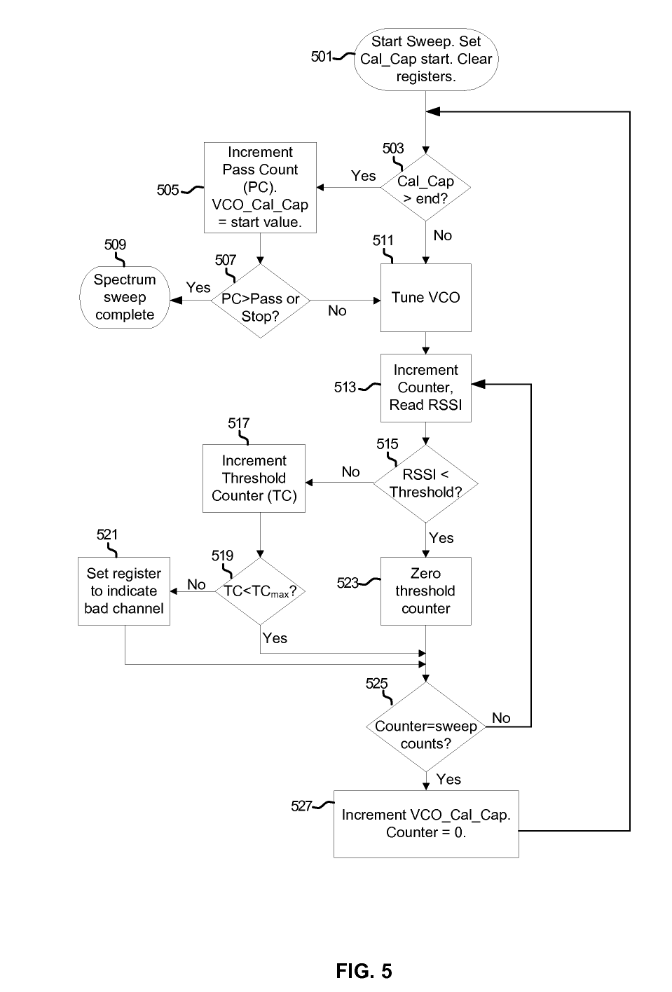

FIG. 5 is a flow diagram illustrating an exemplary Bluetooth channel sweep without skipped bands, in accordance with an embodiment of the invention. Referring to FIG. 5, in step 501, the frequency sweep may start with the VCO_CAL_CAP indicator set to the start value, which may correspond to the lowest frequency of the desired frequency sweep. The bad channel and counter registers may be cleared. In step 503, in instances where the VCO_CAL_CAP identifier may be greater than that calibrated for the maximum frequency of the sweep, the process may proceed to step 505 where the pass count (PC) may be incremented, and VCO_CAL_CAP identifier may be set to the value corresponding to the low frequency in the BT frequency sweep, before proceeding to step 507. In step 507, in instances where the PC value may be greater than a pass or stop value, in other words, the number of desired frequency sweeps has been reached, the process may proceed to end step 509, spectrum sweep complete.

If in step 503, the VCO_CAL_CAP identifier is not above that which corresponds to the maximum frequency, the process may proceed to step 511, where the VCO 319 may be tuned to the desired frequency. In step 513, the counter, or number of scans made in a particular band, may be incremented, and the RSSI value measured.

In step 515, in instances where the RSSI may be greater than the threshold value, the process may proceed to step 517 where the threshold counter (TC), which may indicate the number of times an interferer was measured in a channel, may be incremented, followed by step 519. In step 519, in instances where TC may be less than TCₘₐₓ, which may correspond to the number of times an interferer may be measured before considering a channel to be bad, the process may proceed to step 525. If TC may be greater than TCₘₐₓ, the process may proceed to step 521, where the register associated with the current measured channel may be set to indicate a bad channel, before proceeding to step 525. If, in step 515, the RSSI may be less than the threshold value, the process may proceed to step 523 where TC may be set to zero before proceeding to step 525.

In step 525, in instances where the counter may be less than the number of desired scans of each channel, the process may step back to step 513. If the counter may equal the number of desired scans of each channel, the process may proceed to step 527 where the VCO_CAL_CAP identifier may be incremented, and the counter may be set to zero to enable a count of the number of scans in the next channel, before proceeding to step 503.

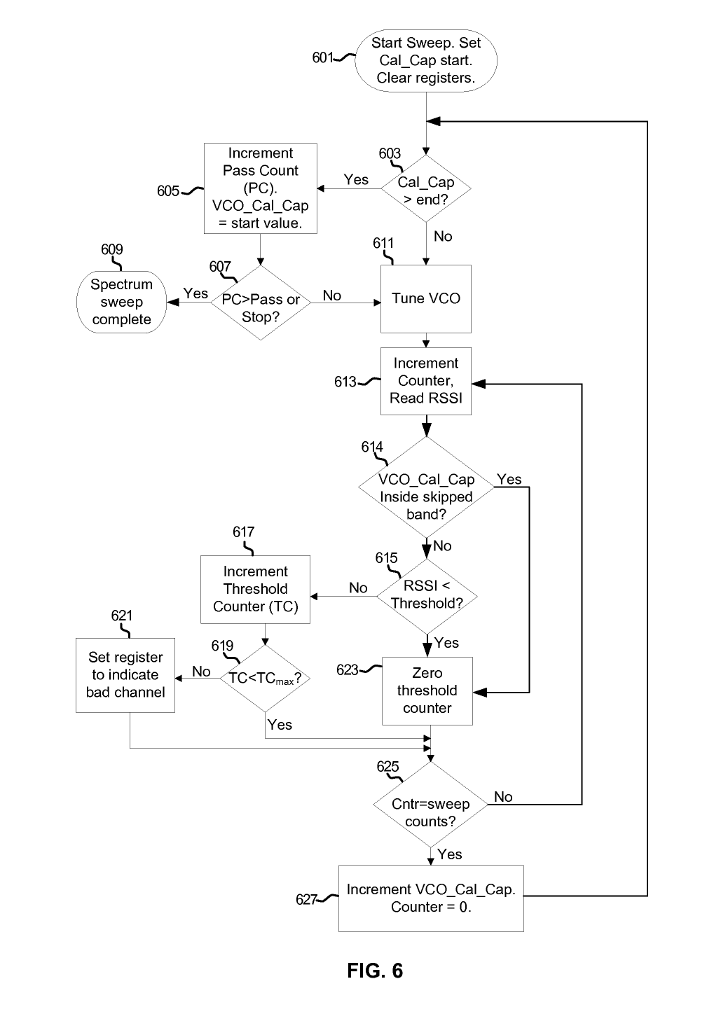

FIG. 6 is a flow diagram illustrating an exemplary Bluetooth channel sweep with skipped bands where the signal is ignored in the skipped band, in accordance with an embodiment of the invention. Referring to FIG. 6, in step 601, the frequency sweep may start with the VCO_CAL_CAP indicator set to the start value, which may correspond to the lowest frequency of the desired frequency sweep. The bad channel and counter registers may be cleared. In step 603, in instances where the VCO_CAL_CAP identifier may be greater than that calibrated for the maximum frequency of the sweep, the process may proceed to step 605 where the pass count (PC) may be incremented, and VCO_CAL_CAP identifier may be set to the value corresponding to the low frequency in the BT frequency sweep, before proceeding to step 607. In step 607, in instances where the PC value may be greater than a pass or stop value, in other words, the number of desired frequency sweeps has been reached, the process may proceed to end step 609, spectrum sweep complete.

If in step 603, the VCO_CAL_CAP identifier is not above that which corresponds to the maximum frequency, the process may proceed to step 611, where the VCO 319 may be tuned to the desired frequency. In step 613, the counter, or number of scans made in a particular band, may be incremented, and the RSSI value measured. In step 614, in instances where the VCO_CAL_CAP identifier is inside a frequency band to be skipped, the process may skip to step 623 where TC may be set to zero before proceeding to step 625. In step 614, in instances where the VCO_CAL_CAP identifier is not inside a frequency band to be skipped, the process may proceed to step 615.

In step 615, in instances where the RSSI may be greater than the threshold value, the process may proceed to step 617 where the threshold counter (TC), which may indicate the number of times an interferer was measured in a channel, may be incremented, followed by step 619. In step 619, in instances where TC may be less than TCₘₐₓ, which may correspond to the number of times an interferer may be measured before considering a channel to be bad, the process may proceed to step 625. If in step 619, TC may be greater than TCₘₐₓ, the process may proceed to step 621, where the register associated with the current measured channel may be set to indicate a bad channel, before proceeding to step 625. If, in step 615, the RSSI may be less than the threshold value, the process may proceed to step 623 where TC may be set to zero before proceeding to step 625.

In step 625, if the counter may be less than the number of desired scans of each channel, the process may step back to step 613. If the counter may equal the number of desired scans of each channel, the process may proceed to step 627 where the VCO_CAL_CAP identifier may be incremented, and the counter may be set to zero to enable a count of the number of scans in the next channel, before proceeding to step 603.

In an embodiment of the invention, a method and system are disclosed for sweeping a signal detection frequency one or more times across a plurality of steps in a frequency range. The measured signal strength 200 at each of the plurality of steps may be compared to a predetermined threshold 201, and a status 210 may be stored for each of the plurality of steps. The status 210 may be dependent on the presence of a measured signal strength 200 above the predetermined threshold 201. The signal detection frequency may be swept utilizing a voltage controlled oscillator 319, which may be tuned via a control voltage and/or calibration capacitors. One or more steps may be skipped in the sweeping of the signal detection frequency when a signal strength 200 measured at the one or more steps may be greater than the predetermined threshold 201. The skipping of the one or more steps may occur after more than one of the measurements of the signal strength 200 may be above the threshold 201. The plurality of steps may be of a variable frequency width, and the frequency range may comprise the Bluetooth frequency band from 2.40 GHz to 2.48 GHz. The detection frequency may be swept over a subset of the Bluetooth frequency band, and may be swept on a periodic basis.

Certain embodiments of the invention may comprise a machine-readable storage having stored thereon, a computer program having at least one code section for communicating information within a network, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for wireless communication, the method comprising:
in a Bluetooth radio,
sweeping a signal detection frequency one or more times across a frequency range in a plurality of steps;
comparing a measured signal strength at each of said plurality of steps to a threshold; and
storing a status of each of said plurality of steps, wherein said status is dependent on the presence of a measured signal strength above said threshold.

2. The method according to claim 1, comprising sweeping said signal detection frequency utilizing a voltage controlled oscillator.

3. The method according to claim 2, comprising tuning said voltage controlled oscillator via a control voltage.

4. The method according to claim 2, comprising tuning said voltage controlled oscillator via calibration capacitors.

5. The method according to claim 1, comprising skipping one or more steps in said sweeping of said signal detection frequency when a signal strength measured at said one or more steps is greater than said threshold.

6. The method according to claim 5, wherein said skipping of said one or more steps occurs after more than one of said measurement of said signal strength above said threshold.

7. The method according the claim 1, wherein said plurality of steps are of a variable frequency width.

8. The method according to claim 1, wherein said frequency range comprises the Bluetooth frequency band from 2.40 GHz to 2.48 GHz.

9. The method according to claim 8, comprising sweeping said signal detection frequency over a subset of said Bluetooth frequency band.

10. The method according to claim 1, comprising sweeping said signal detection frequency on a periodic basis.

11. A system for wireless communication, the system comprising:
one or more circuits in a Bluetooth radio that sweep a signal detection frequency one or more times across a frequency range in a plurality of steps;
said one or more circuits compares a measured signal strength at each of said plurality of steps to a threshold; and
said one or more circuits stores a status of each of said plurality of steps, wherein said status is dependent on the presence of a measured signal strength above said threshold.

12. The system according to claim 11, wherein said one or more circuits sweep said signal detection frequency utilizing a voltage controlled oscillator.

13. The system according to claim 12, wherein said one or more circuits tune said voltage controlled oscillator via a control voltage.

14. The system according to claim 12, wherein said one or more circuits tune said voltage controlled oscillator via calibration capacitors.

15. The system according to claim 11, wherein said one or more circuits skip one or more steps in said sweeping of said signal detection frequency when a signal strength measured at said one or more steps is greater than said threshold.

16. The system according to claim 15, wherein said skipping of said one or more steps occurs after more than one of said measurement of said signal strength above said threshold

17. The system according to claim 11, wherein said plurality of steps are of a variable frequency width.

18. The system according to claim 11, wherein said frequency range comprises the Bluetooth frequency band from 2.40 GHz to 2.48 GHz.

19. The system according to claim 18, wherein said one or more circuits sweep said signal detection frequency over a subset of said Bluetooth frequency band.

20. The system according to claim 11, wherein said one or more circuits sweeps said signal detection frequency on a periodic basis.
